(19) United States
(12) Patent Application Publication
(10) Pub. No.: US 2003/0223587 A1
(43) Pub. Date: Dec. 4, 2003

(54) Classified communication system which classifies the signal between interfaces and supports a media transport encoding scheme for a direct current balanced stream simultaneously

(75) Inventor: Hiroaki Nishi, Hachioji (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/231,010

(22) Filed: Aug. 30, 2002

(30) Foreign Application Priority Data
May 29, 2002 (JP) 2002-154937

(51) Int. Cl. H04L 9/00

(52) U.S. Cl. 380/284

(57) ABSTRACT

Disclosed is a proposal for a technique of classifying communication for Layers 1 and 2 or higher, and thereby establishment of a necessary method of safely and simply interchanging a secret key, an authentication method, an error detection method, and a recovery method. It is necessary to decrease the amount of hardware needed for establishing these. We invented a hardware-based method of safely and simply interchanging a key needed for classified connection. A procedure according to the invention interchanges a key using a feature attributed to a classification conversion to which an commutative law is applicable. The procedure can simultaneously confirm normal connection of both outward and homeward routes and is also usable as an DC balanced encoding system as a result of classification. Layers 1 and 2 can be classified because the classified connection is based on hardware. Even if a signal is monitored directly or a generated noise is observed, it becomes difficult to retrieve not only information included in a packet's payload, but also information such as a header and a trailer where information such as a destination, a packet type, etc. is described, and communication state information such as a congestion degree of packets. With respect thereto, we also invented an authentication method, an error detection method, and a method of recovery from an error-detected state.

### BACKGROUND OF THE INVENTION

1. Field of the Invention

The present invention relates to a technology for classifying signals during communication and particularly to exchange, authentication, and error correction of secret keys during a classified communication using a secret key.

2. Description of Related Art

The classification is a technology that scrambles original text (plaintext) and prevents it from being read by anyone other than interested parties who know a rule (key) of the scrambling. A sender creates encrypted text using an encryption key. A recipient decodes the received encrypted text to the original text by using a decryption key. When the encryption key is the same as the decryption key, these are referred to as common secret keys or simply as secret keys. For a data communications system, the technology for classifying communication contents is important. The conventional classification technique generally provides encryption at Layer 2 or higher according to the OSI model. No classification is applied to at least portions other than the payload at Layer 2. In an IP communication network, for example, the encryption is available for portions higher than the payload at Layer 3. No encryption is performed for IP headers or Ethernet frame headers. Accordingly, there is a problem in that a third party can directly monitor or intercept packets by means of hardware probing or using electromagnetic waves and noises generated from devices, and thus falsify a sender and a recipient or monitor the traffic.

FIG. 12 shows an applicable scope of the conventional classification. The conventional technique can classify the payload at Layer 3 or higher. The payload's header and trailer cannot be classified. However, the following information is contained in portions that cannot be classified by the conventional technique. Therefore, there are security problems just because each of the information cannot be classified.

1. A packet header contains address information about a sender or a recipient. This information can uniquely specify the sender or the recipient and is linked to individuals and organizations. Accordingly, this information is associated with very important privacies. Falsifying or monitoring this information causes various security problems such as “disguise”, “action monitoring”, “a loss of means for specifying an intruder when an unauthorized access occurs”, etc.

2. The packet header further contains information such as protocol types. This information can be used to specify types of services provided. Consequently, it is possible to specify whether the traffic content is mail, a Web access, or a credit card number or other confidential documents according to https etc. Falsifying or monitoring this information can enable to “disorder or stop services”, “illegally access a system or easily falsify information by specifying classified information”, and “specify and monitor services in progress”. Even if the internal information is classified according to https or the like, no classification is applied to header information in a layer lower than the associated layer. When this portion contains critical information, it is possible to “falsify or monitor information in a higher-layer header”.

3. If a user does not intentionally classify a higher layer, the payload information is not classified. Although an ordinary classification technique can be used as a solution, it becomes possible to view a plaintext password by means of communication probing, falsify or monitor all work contents, accesses, documents, mail messages, etc.

4. An IPv6 header contains a classified identifier that indicates classification of the payload. The IPv6 header and the IPv6 trailer are not classified. No classification is applied to the Ethernet frame or header in the lower data link layer. Generally, IPv6 is recognized to be safe because it has the classification technique by default. However, it becomes possible anew to obtain levels of importance for packets as information newly contained in the IPv6 header, transit points for source routing, classification methods, and the other information.

Classification systems include a secret key cryptosystem and a public key cryptosystem. The secret key cryptosystem uses the same key for encryption and decryption. The public key cryptosystem uses a set of an encryption key and a decryption key. The encryption key is used as a public key and is shared by parties who interchange information. Only a recipient owns the decryption key as a secret key for cryptographic processing. The secret key cryptosystem can execute 100 to 1,000 times faster than the public key cryptosystem. Generally, the public key system is used to interchange secret keys associated with the classification. However, since the public key system is accompanied by complicated computation, the hardware implementation increases implementation costs. Accordingly, the classification based on the secret key cryptosystem is optimal for the hardware implementation. However, there has been no method of easily and safely interchanging secret keys between hardware components.

As known examples, P2001-203679A uses a terminal key and a group key for double locking to hide terminals that perform the classified communication. P2000-49769A provides a technique using a public key that can be difficultly transformed to hardware. P2001-345795A uses another common secret key to interchange secret keys. JP-A No. 298470/1999 uses a separate means for distributing keys offline. P2000-261426A uses a selected selection key and a hold key to create a conversion and needs to send selection parameter information. Accordingly, the parameter and the hold key need to be interchanged as plaintext.

### SUMMARY OF THE INVENTION

It is an object of the present invention to complete the classification at Layers 1 and 2 even if whatever protocol is provided at a higher layer. The other object of the present invention is to provide means for: authentication to prevent a third party from being disguised as an interested party for communication; error detection in classified information; and recovery from an error state. The present invention paid attention to the following problems in the prior art.

1. P2001-203679A hides terminals that perform the classified communication, but cannot hide a group to which the terminals belong, and cannot hide the traffic. A means for classifying all signals is required.

2. P2000-49769A is a technique using a public key. The generally used public key cryptosystem has difficulty in implementation because many procedures are needed for a hardware configuration; a large amount of hardware is required; or the algorithm is inappropriate for parallel processing. Even if a secret key is used, the software implementation increases processing costs. Accordingly, the classification processing becomes a bottleneck for high-speed communication in which a network communication rate exceeds a processor's processing rate.

3. P2001-345795A uses another common secret key to interchange secret keys. Since interchanging secret keys requires a key other than the secret keys needed for an interchange, a storage area is needed for that extra key, increasing the amount of hardware. Therefore, there is required a technique that does not use information other than the keys needed for the interchange.

4. Since JP-A No. 298470/1999 uses a separate means for distributing keys offline, it is necessary to separately provide the means for distributing keys. Further, extra classification is needed for key distribution. There is required a means that does not require a communication means for the key interchange except physical signal paths for actually interchanging information.

5. Since P2000-261426A uses a selected selection key and a hold key to create a conversion, it is necessary to send selection parameter information. The parameter and the hold key need to be interchanged as plaintext. Accordingly, it is necessary to eliminate the need for sending parameters other than the selected keys, allow the lower layer to independently and freely create a secret key, and send a key by classification. The inventors further paid attention to the following problems.

6. It is necessary to combine the conventionally needed protocol with hardware needed for interchange procedures and encryption of secret keys, thus decreasing the amount of additional hardware needed.

7. The safe interchange of secret keys requires authentication. When information is classified at Layer 1 or 2, an error detection means is required in a classified state. Further, when an error is detected, it is necessary to provide a means for recovery from the state including the error

In order to solve the above-mentioned problems, the present invention use the following means.

With respect to a physical configuration for classification, it is impossible to classify portions other than layers processed by the software as long as only the software classification is used. The hardware classification is needed to classify information such as the header, the trailer, etc. in a lower layer other than the payload. The hardware classification is used to provide a configuration that allows the use of plaintext only for a die in LSI or the like where internal analysis is difficult physically. This is called the complete classification.

For hardware classification, it is desirable to provide the classification using a secret key that can be easily realized by hardware.

When a classification procedure is taken into consideration, the following describes a typical procedure for a classified communication method of interchanging secret keys in communication according to the present invention.

(1) A sending side classifies its secret key KA to fA(KA) using the secret key KA and sends fA(KA) to a receiving side.

(2) When receiving fA(KA), the receiving side classifies fA(KA) to fB·fA(KA) using its secret key KB and returns fB·fA(KA) to the sending side.

(3) When receiving fB·fA(KA), the sending side converts fB·fA(KA) to fB(KA) using the sending side's secret key KA and sends fB(KA) to the receiving side.

(4) The receiving side receives fB(KA) using the receiving side's secret key KB and converts fB(KA) to plaintext to obtain the secret key KA.

The above-mentioned procedure allows the secret key KA to be transferred over the network with the confidentiality maintained. Here, the procedure uses the following commutative law.

$${f}_{A}^{- 1} \cdot {f}_{B} \cdot {f}_{A} ( {K}_{A} ) = {f}_{A}^{- 1} \cdot {f}_{A} \cdot {f}_{B} ( {K}_{A} ) = {f}_{B} ( {K}_{A} ) \qquad Equation 1$$

The above-mentioned procedure is implementable by means of software or hardware. The use of this secret key interchange technique can decrease the hardware amount without requiring information such as other keys or parameters for interchanging secret keys. Further, the above-mentioned key interchange means does not need an extra communication means performed on a physical connection for actually interchanging information.

The present invention classifies a key itself during interchange of keys. After secret keys are interchanged, the present invention classifies all signals carried over an associated physical connection. Accordingly, it becomes difficult to retrieve information even if the physical connection is directly monitored. Secret keys used in the present invention may be freely generated by random numbers and the like at Layer 1 or 2 that actually performs classification.

The present invention can encrypt a secret key, safely and easily interchange it, and confirm a successful connection of outward and homeward routes, eliminating the need for an extra confirmation means. When a signal after classification is DC-balanced-encoded according to some classification conversions, an extra DC balanced encoding means need not be provided. The DC balanced encoding can encode clocks and data and ensure band characteristics of an optical fiber etc. used for communication.

The present invention includes an authentication means for ensuring safe key interchange, a means for determining an error, and, when an error is detected, a means for recovery from an erratic state. According to one aspect of the present invention, a node for performing communication comprises an encode and decode means for classification; a means for generating factors needed for the classification used by the encode and decode means; and a control means for interchanging a secret key and confirming connection of outward and homeward routes.

For example, a node apparatus implements communication classified by a secret key between two nodes. The node apparatus comprises an encoder which classifies information to be sent; a circuit which generates factors needed for the classification used by the encoder; a decoder which converts received information to plaintext; a circuit which generates factors needed for the classification used by the decoder; and a circuit which simultaneously provides control to confirm normal connection of outward and homeward routes and to interchange keys. Further, it is possible to provide sending and receiving sides with a buffer for storing keys used for authentication.

The present invention provides communication based on secret keys and enables the classification for Layers 1 and 2. This enables a safe interchange of secret keys during communication through the use of secret keys. It is possible to use both the DC balanced encoding system and the connection confirmation procedure based on Ping/Pong by expanding both mechanisms.

Accordingly, the present invention can provide a means for classifying not only information to be transmitted, but also the management or path information attendant on that information, and communication states and frequency even if a higher layer uses whatever protocol and the software or hardware is used to provide a monitoring means for directly probing a communication path. Further, there is a small increase in the amount of hardware. It is possible to provide authentication and error detection means for preventing any third party from being disguised as an interested party for communication and a means for recovery from an error state.

Other and further objects, features and advantages of the invention will appear more fully from the following description.

### BRIEF DESCRIPTION OF THE DRAWINGS

FIG. 1 is a flowchart showing a communication sequence at initial connection and a flow of processing between hosts to simultaneously perform a process for confirming connection of outward and homeward routes and a process for interchanging secret keys;

FIG. 2 is a flowchart showing a communication sequence at initial connection and a flow of processing between hosts to simultaneously perform a process for confirming connection of outward and homeward routes and a process for interchanging secret keys by focusing on transmission of secret keys on a single host only;

FIG. 3 is a flowchart showing a communication sequence at initial connection and a flow of processing between hosts to simultaneously perform a process for confirming connection of outward and homeward routes and a process for interchanging secret keys by focusing on reception of secret keys on a single host only;

FIG. 4 is a block diagram showing a configuration of hardware according to the present invention;

FIG. 5 is a state transition diagram showing state transition of a communication sequence at initial connection between hosts to simultaneously perform a process for confirming connection of outward and homeward routes and a process for interchanging secret keys;

FIG. 6 is a flowchart showing state transition of some operations in a Ping/Pong control circuit as an applicable example of state transition of a communication sequence at initial connection between hosts to simultaneously perform a process for confirming connection of outward and homeward routes and a process for interchanging secret keys;

FIG. 7 depicts four types of packet formats used for performing a Ping/Pong sequence according to the present invention;

FIG. 8 is a flowchart in a transition form showing a procedure to determine whether input data in FIG. 5 is a packet used for Ping/Pong or classified data wherein the input data in FIG. 5 is information needed for state transition of operations in the Ping/Pong control circuit in FIG. 4;

FIG. 9 is a flowchart in a transition form showing determination whether or not an error occurs during classified communication and a procedure needed for recovery;

FIG. 10 is a flowchart in a transition form showing determination whether or not an error occurs during classified communication provided with an error correction code and a procedure needed for recovery;

FIG. 11 is a block diagram showing a hardware configuration provided with a authentication mechanism according to the present invention; and

FIG. 12 diagrams an applicable scope of a conventional classified connection.

### DETAILED DESCRIPTION OF THE PREFERRED EMBODIMENTS

Embodiments of the present invention will be described with reference to the accompanying drawings. In the following embodiments, a classification means uses random numbers but is not limited thereto. An error detection code in the following embodiments may be an error correction code.

(Exemplary Embodiment 1)

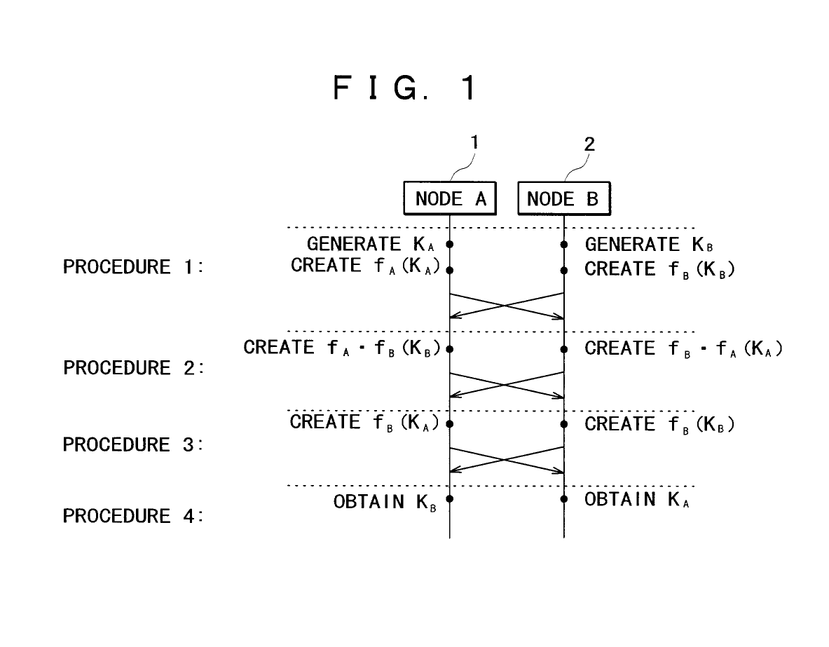

FIG. 1 shows a procedure for interchanging secret keys according to the present invention. When a secret key system is used, it is necessary to provide a method of safely interchanging keys between interfaces at remote places. The present invention uses a conversion capable of applying an commutative law to secret keys, i.e., a technique called double locking. The commutative law is applicable to the secret key system that generally adds terms of a random number sequence to plaintext or performs an XOR operation for these terms. The secret key system is usable for the double locking technique. When the commutative law can be applied to a conversion according to the classification, it may be preferable to reverse the order of a locking sequence and an unlocking sequence. When this feature is used, it is possible to safely interchange secret keys between interfaces. FIG. 1 shows a flow of interchanging respective secret keys between a node A 1 and a node B 2 adjacent to each other.

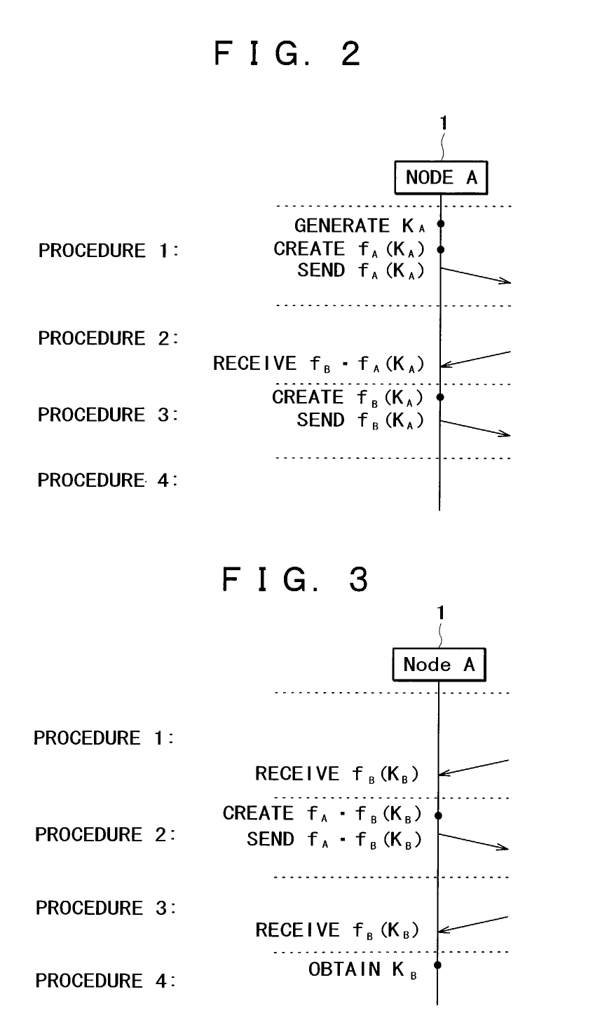

FIG. 2 shows a flow of sending keys when one node is focused.

FIG. 3 shows a flow of receiving keys when one node is focused.

A secret key managed by the node A 1 is assumed to be KA; a secret key managed by the node B 2 to be KB; a conversion by KA to be fA; and a conversion by KB to be fB. The respective nodes may freely generate KA and KB by using random numbers. With reference to FIG. 1, procedures will now be described by paying attention to the node A.

Procedure 1: The node A 1 creates and uses the key KA. The node A 1 locks the key KA with the key KA itself to generate fA(KA) and sends it to the node B. Namely, the node A 1 locks its key by using the key itself and sends the same key. Since fA(KA) is classified, it is difficult to view keys during communication.

Procedure 2: When receiving fA(KA), the node B double-locks it using the key KB the node B creates and uses. The node B converts fA(KA) to fB·fA(KA) and sends it to the node A. The data fB·fA(KA) during communication is classified.

Procedure 3: The node A uses the commutative law (fB·fA(KA)−fA·fB(KA)) to unlock the received fB·fA(KA) using the key KA.

$${f}_{A}^{- 1} \cdot {f}_{B} \cdot {f}_{A} ( {K}_{A} ) = {f}_{A}^{- 1} \cdot {f}_{A} \cdot {f}_{B} ( {K}_{A} ) = {f}_{B} ( {K}_{A} ) \qquad Equation 2$$

Since this equation is satisfied, fB(KA) is obtained. This is resent to the node B. The data fB·fA(KA) during communication is classified.

Procedure 4: The node B unlocks the received fB(KA) using the key KB to obtain KA. Further, the node B interchanges the key KB in the same manner as for the node A (see FIG. 1). By following the above-mentioned procedures, the nodes A and B can interchange the respective secret keys without generating an extra secret key while maintaining the classification during the secret key interchange. After these keys are interchanged, they are used to classify all signals flowing through a link including an IDLE signal indicating that no information flows. Since all signals flowing through a link are classified, whether or not data flows is classified. It is difficult to intercept not only packet header information, but also even the traffic.

The keys just need to be interchanged once. Upon completion of the interchange, the interchanged secret keys can be used for communication without interchanging the secret keys again.

The above-mentioned procedures are implementable by means of software or hardware. The description here shows an example by means of hardware more appropriate for the classification.

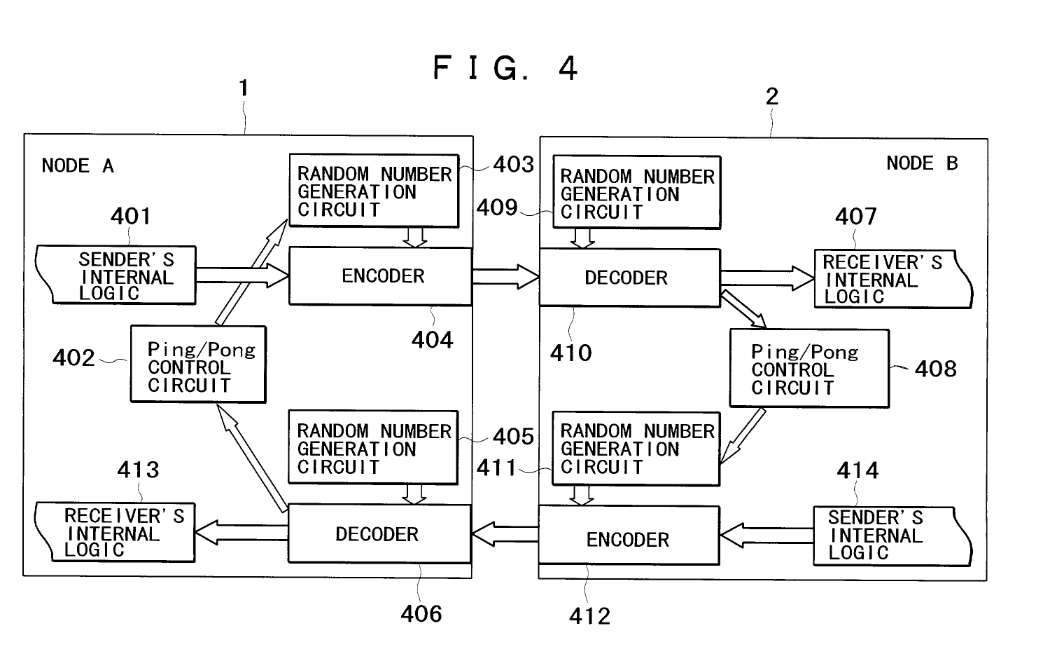

FIG. 4 shows a hardware configuration according to the present invention. Encoders 404 and 412 use random numbers generated from corresponding random number generators 403 and 411 to classify signals from internal logics 401 and 414. Adversely, decoders 406 and 410 use random numbers generated from random number generators 405 and 409 to convert the signals to plaintext and pass the signals to internal logics. Since secret keys are interchanged with each other, the random number generator 403 and the random number generator 409 generate the same random number sequence. The random number generator 405 and the random number generator 411 generates the same random number sequence. Accordingly, the encoder and the decoder corresponding to each of these generators can operate in pairs.

A procedure to confirm normal connection of outward and homeward routes is called Ping/Pong. In addition, Ping/Pong control circuits 402 and 408 simultaneously control a procedure for interchanging secret keys. Namely, secret keys are classified and interchanged between outward and homeward routes during a process of confirming normal connection of the outward and homeward routes at the sending and receiving sides. Each node stores a secret key interchanged at an initial connection and a secret key generated by the node itself. The node adds these secret keys to the next connection for authentication.

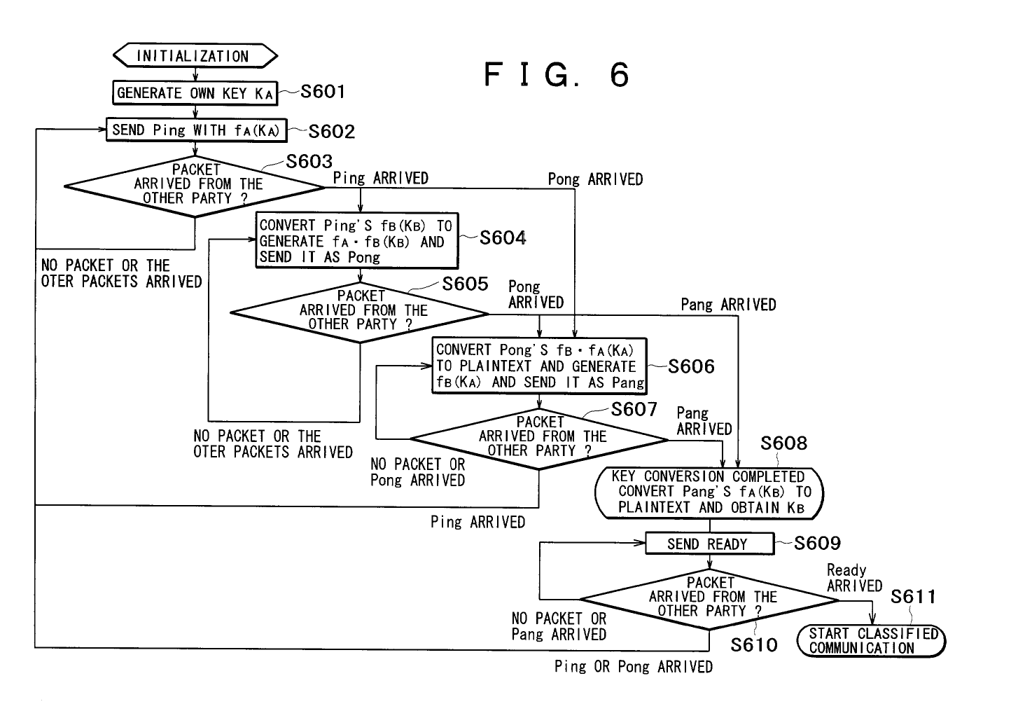

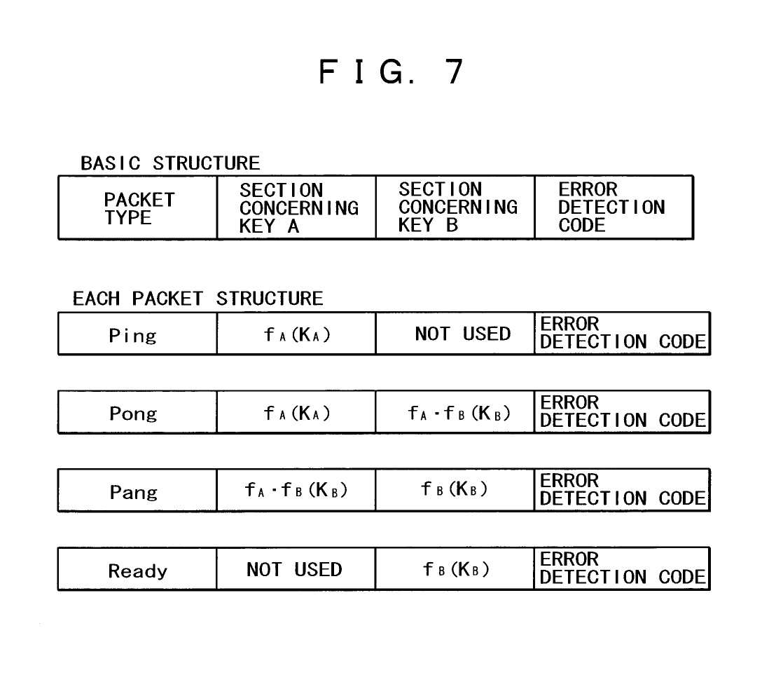

FIG. 6 shows an operation in the Ping/Pong control circuit. FIG. 7 show four types of packet formats used for the assumed Ping/Pong sequence. The present invention uses the following packets: Ping to send a first key; Pong as a response to Ping; Pang as a response to Pong; and Ready to indicate a communicable state.

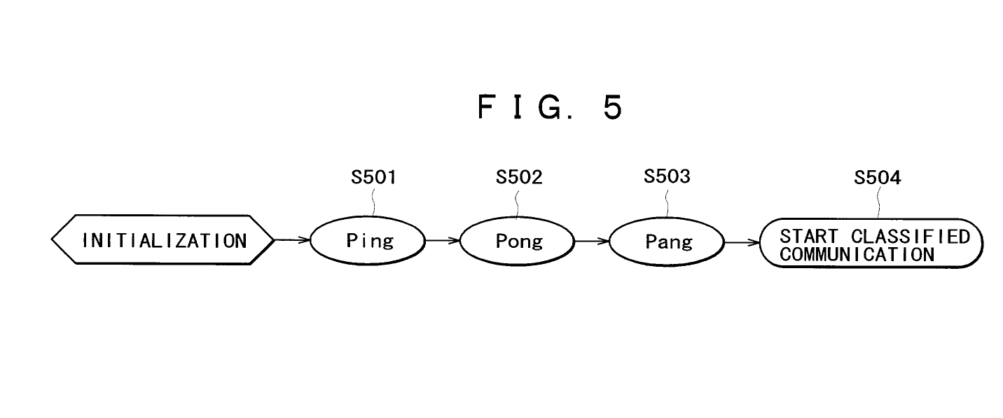

FIG. 5 shows simplified state transition of key interchange and Ping/Pong sequences according to this system. The state transition includes a Ping state at S501 equivalent to three interchanges of a key, a Pong state at S502 as a response to Ping, a Pang state at S503 as a response to Pong, and then a state capable of starting the classified communication at S504. FIG. 6 shows a more specific and detailed state transition diagram.

As an embodiment, FIG. 6 shows a specific state transition diagram for a means to interchange secret keys and simultaneously confirm communicability of the outward and homeward routes. At S601, the node A first generates its own key KA. At S602, the node A classifies its key KA using the same key KA to generate fA(KA). At S603, the node A checks if a packet arrives from the node B as a communication destination. When no packet arrives or a packet other than Ping and Pong packets arrives, the process proceeds to S602. When Ping is received, the process proceeds to S604. When Pong is received, the process proceeds to S606. At S604, the node A classifies fB(KB) included in the received Ping packet using its key KA to generate fA·fB(KB). The node A sends fA·fB(KB) together with Pong to the node B. At S605, the node A checks if a packet arrives from the node B. When no packet arrives or a packet other than Ping and Pong packets arrives, the process returns to S604. When Pong arrives, the process proceeds to S606. When Pang arrives, the process proceeds to S608. At S606, the node A converts fB·fA(KA) included in the received Pong packet to plaintext using its own key KA. The plaintexting process generates fB(KA) using the following equation according to the commutative law.

$${f}_{A}^{- 1} \cdot {f}_{B} \cdot {f}_{A} ( {K}_{A} ) = {f}_{A}^{- 1} \cdot {f}_{A} \cdot {f}_{B} ( {K}_{A} ) = {f}_{B} ( {K}_{A} ) \qquad Equation 3$$

The node A sends fB(KA) together with Pang to the node B. At S607, the node A checks if a packet arrives from the node B. When no packet or Pong arrives, the process proceeds to S604. When Ping arrives, the process proceeds to S602 again because the node B is considered to return to the initial state. When Pang arrives, the process proceeds to S608. At S608, the node A converts fA(KB) included in Pang to plaintext and obtains the node B's secret key KB. The key interchange process is now complete. The node A starts synchronization with the node B. The node A sends Ready at S609, and checks if a packet arrives from the node B at S620. When no packet or Pang arrives, the process proceeds to S609 again because the node B is not Ready yet. When Ping or Pong arrives, the process proceeds to S602 again because the node B is considered to return to the initial state. When Ready arrives, the process proceeds to S611 and starts the classified communication.

At S611, the node A starts generating a random number for plaintexting at the timing when the node A receives the first classified information. The use of an error detection code helps identify whether or not the information is classified.

FIG. 7 depicts four types of packet formats used for performing a Ping/Pong sequence according to the present invention.

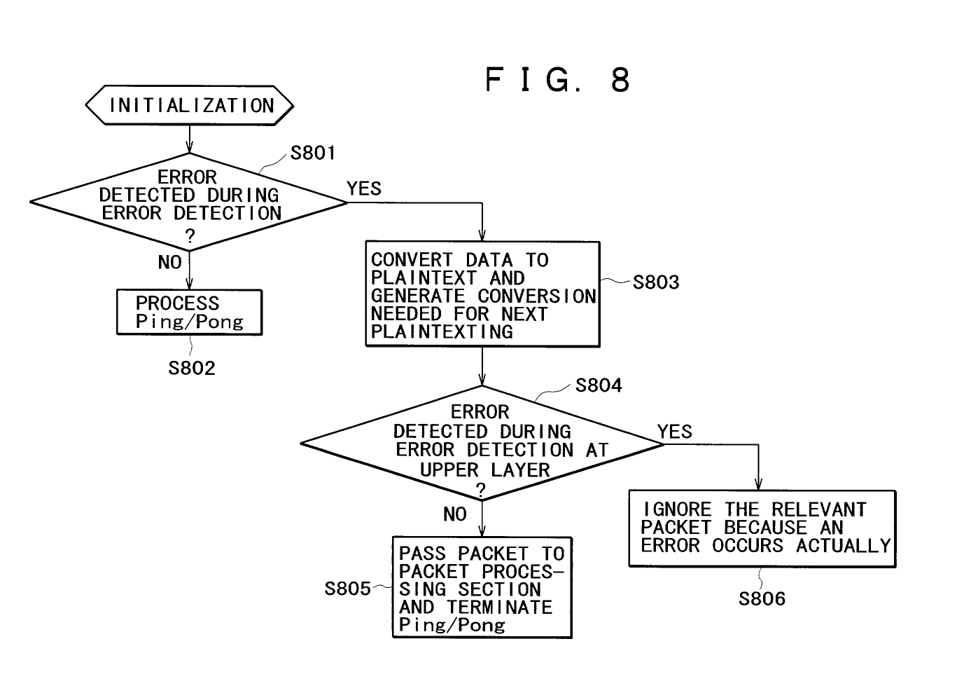

FIG. 8 is a flowchart in a transition form showing a procedure to determine whether input data in FIG. 5 is a packet used for Ping/Pong or classified data wherein the input data in FIG. 5 is information needed for state transition of operations in the Ping/Pong control circuit in FIG. 4.

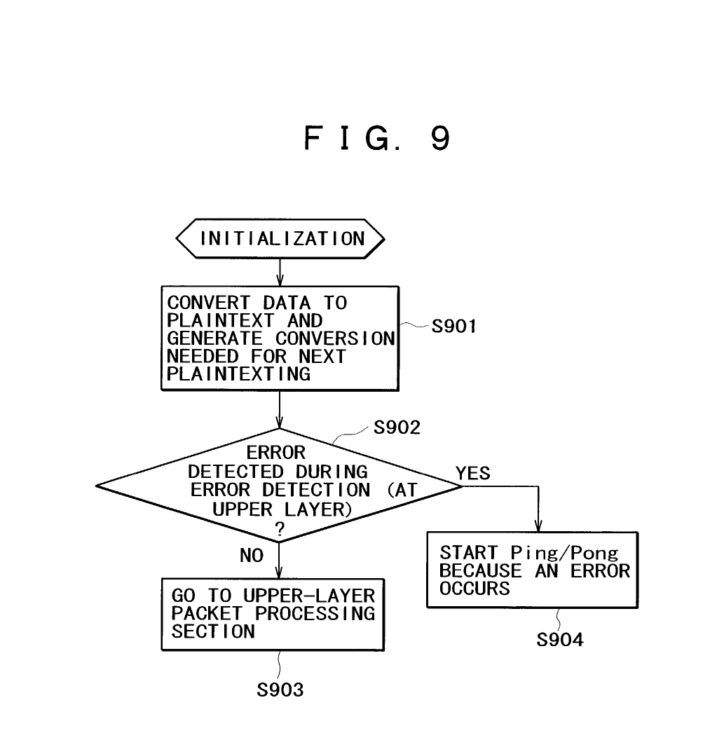

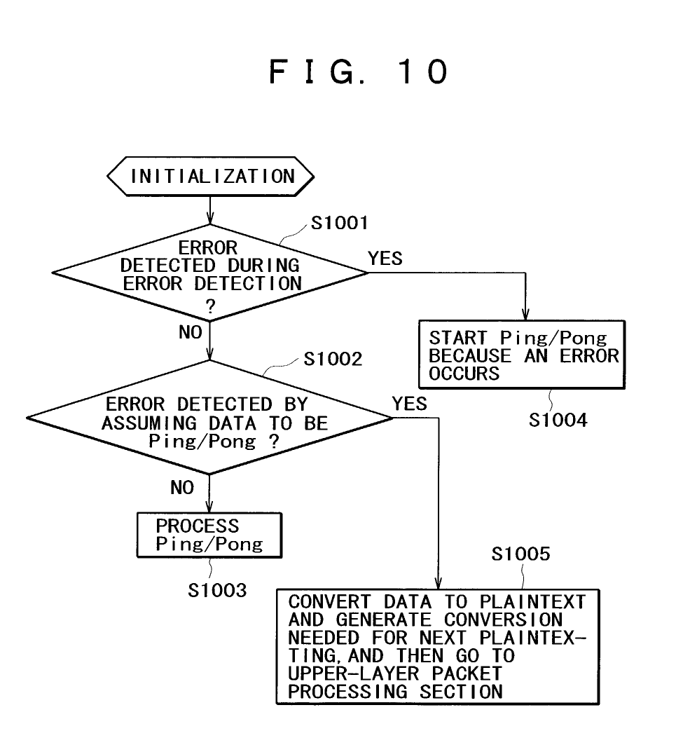

FIG. 9 is a flowchart in a transition form showing determination whether or not an error occurs during classified communication and a procedure needed for recovery.

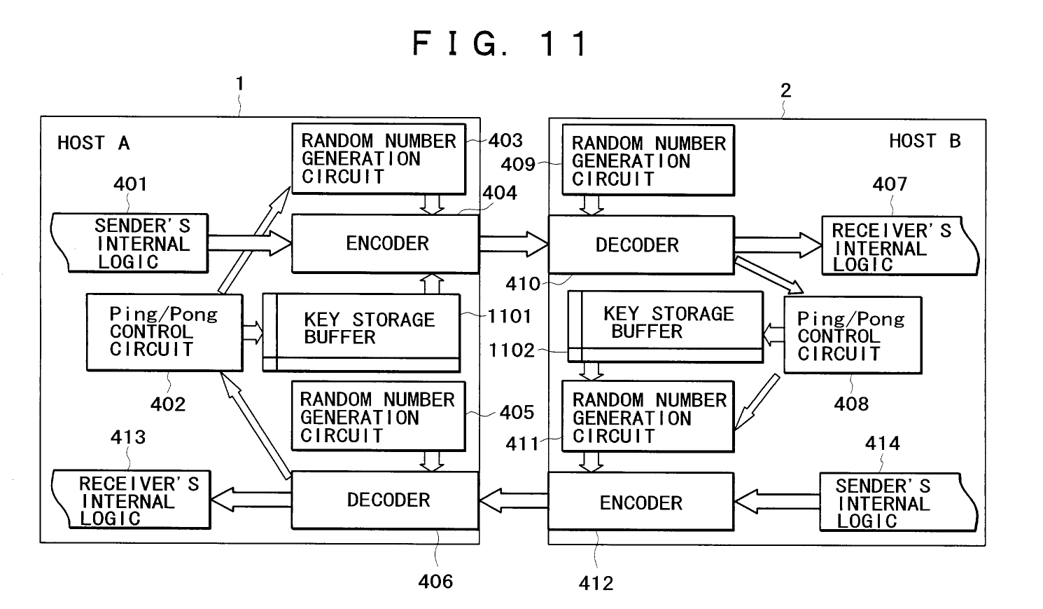

FIG. 10 is a flowchart in a transition form showing determination whether or not an error occurs during classified communication provided with an error correction code and a procedure needed for recovery.

As shown in FIG. 7, an error detection code is provided for each of Ping, Pong, Pang, and Ready. The means in FIGS. 8, 9, and 10 determine whether or not Ping/Pong is classified. Through the use of these means, it is possible to determine whether the procedure is classified communication or an initial Ping/Pong procedure, and to enable error detection and recovery. These procedures make it possible to confirm connected communication for both the outward and homeward routes simultaneously.

The key interchange according to the above-mentioned procedures in this embodiment performs an extended Ping/Pong procedure to confirm communicability of both the outward and homeward routes for communication between the nodes. Consequently, applying the present invention does not greatly increase the necessary traffic.

(Exemplary Embodiment 2)

The following describes a case where an error detection capability is provided to the present invention according to the embodiment 1. When there is not provided an error detection code or the like other than classified data, it is difficult to determine whether or not an error occurs just by viewing the classified content. Accordingly, the error detection first requires plaintexting, and then detects an error. At S801 in FIG. 8, the error detection is performed on the assumption that a received Ping/Pong packet is provided with the error detection code. When no error is detected, it is assumed that a packet for correct Ping/Pong has arrived. Then, the Ping/Pong sequence is performed at S802. That is, the control procedure in FIG. 6 is performed. When an error is detected, two possibilities are available. One is that the error detection is unsuccessful due to classification. The other is that an error occurs actually. At S803, the same packet is converted to plaintext on the assumption that the packet is classified. At S804 thereafter, the error detection at a higher layer is used to determined whether or not an error is detected. When no error is detected at S805, it is found that the classified communication was performed. Data is passed to a packet processing section to terminate Ping/Pong. When an error is detected at S806, it is found that an error actually occurred. The packet concerned is ignored. The procedure in FIG. 6 is configured to ensure the operation even if any of the Ping, Pong, Pang, and Ready packets is processed unsuccessfully. No problem arises if these packets are ignored. The following describes a recovery technique when the Ping/Pong sequence terminates and an error occurs during an interchange of the classified information. FIG. 9 shows a recovery operation when an error occurs. At S901, the system performs plaintexting and simultaneously generates a conversion needed for the next plaintexting. At S902, the system checks whether or not an error is detected during the error detection at the higher layer. When no error is detected, the communication is normal. At S903, data is passed to the packet processing section of the higher layer. When an error is detected, a request for forced transition to the Ping state is issued to the control circuit in FIG. 6 in order to perform the error recovery at S904. As a result, a Ping/Pong handshake is reperformed.

(Exemplary Embodiment 3)

Regarding the error detection capability in the embodiment 2, the following describes an embodiment of successively detecting an error by directly providing an error detection code to classified information in addition to the use of the error detection method at a higher layer. In this case, the frequency of error occurrences at an interested physical layer leaks as information. Since this information has no significance on the security, however, a leak of such information causes no problem. FIG. 10 shows a recovery operation in a classified connection having this error detection code. At S1001, it is determined whether or not the error detection detects an error. When an error occurs, the process proceeds to S1004. When no error occurs, the process proceeds to S1002. At S1004, a request for forced transition to the Ping state is issued to the control circuit in FIG. 4 in order to perform the error recovery. As a result, the Ping/Pong handshake is reperformed. When no error occurs, data arrives correctly. The Ping/Pong sequence is assumed and the error detection is performed. It is determined whether the data is classified data or Ping/Pong. When an error is detected, the plaintexting is performed at S1005 because the classified data is received. At the same time, a conversion needed for the next plaintexting is generated. Subsequently, the data converted to plaintext is passed to the packet processing section for the higher layer. When no error occurs, the Ping/Pong sequence is performed at S1003.

(Exemplary Embodiment 4)

The following describes a case of providing the embodiments 1, 2, and 3 with a capability to confirm whether the other party is reliable before a classified connection is performed. If there is provided a capability of automatic reconnection in the event of disconnected communication, an unauthorized user can retrieve plaintext by temporarily disconnecting the communication and inserting another node between the existing nodes. On the contrary, if the capability of automatic reconnection is not provided, it is necessary to confirm the other party for reconnection each time a communication error occurs, complicating the management. Therefore, a means for authentication is provided. The authentication means assumes a first successful connection to be reliable and allows succeeding connections only with the first connection destination.

Each node first stores an initially interchanged secret key as an authentication key in nonvolatile memory or the like contained in the respective hardware. When an external connection is intended, the connection must be classified to prevent probing at the interface. During the classification, the second and later connections use a combination of conversions by means of the secret key and the authentication key or use both keys as parameters for the random number generation sequence as a basis. This permits communication only for the nodes that interchanged the secret key for the first time.

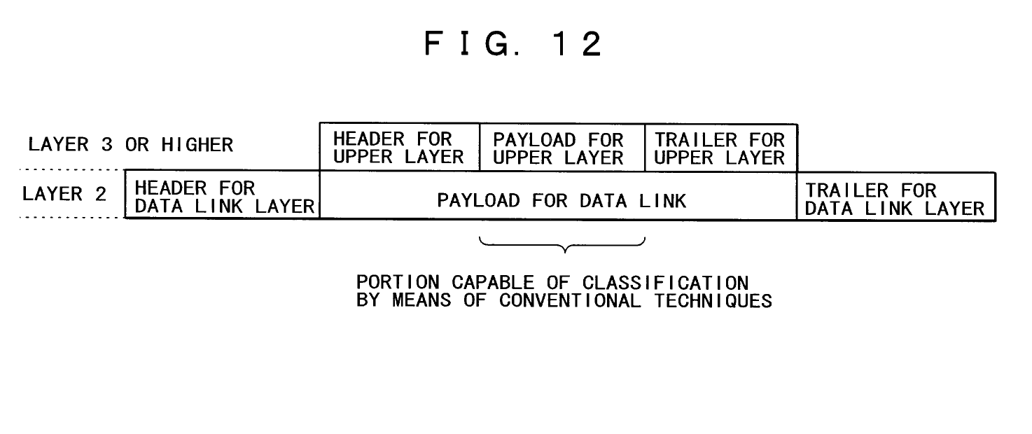

FIG. 11 shows a hardware configuration having an authentication mechanism. There is provided a key storage buffer S1101 needed for authentication. Only during an initial operation, each of the Ping/Pong control circuits 402 and 408 stores the received secret key and its secret key created by itself in the key storage buffer and uses them as authentication keys. After the Ping/Pong sequence is reexecuted, the encoders 404 and 412 perform the subsequent classification based on the key created by the node A 1 or B 2 itself and the key that is initially created by the corresponding node itself and is stored in the key storage buffer. The decoders 406 and 410 perform plaintexting based on the key interchanged by the node A 1 or B 2 with each other and the key that is initially interchanged and is stored in the key storage buffer.

When one node is switched to the other, this authentication key is unnecessary. Before the authentication key is removed, it is necessary to perform a procedure to delete the authentication key beforehand or to call a manager's attention before a new connection is made. To delete the authentication key, it just needs to issue a request for deleting information about the key storage buffer in the information to be classified.

If a conversion used for the classification generates uniform random numbers, values locked by this technique can be used in place of DC balanced encoding systems such as 4B5B, 8B10B, 64B66B, etc. needed for the remote and high-speed signal transmission in order to restrict bands and encode clocks together. When uniform random numbers are used, the DC balanced encoding method provides high performance compared to 64B66B.

When a high-speed line is constructed, there are normally provided both this DC balanced encoding system and the connection confirmation procedure based on Ping/Pong. Since the present invention can be incorporated by expanding both mechanisms, the present invention will cause a small addition to hardware components and a small increase in the amount of hardware.

The foregoing invention has been described in terms of preferred embodiments. However, those skilled, in the art will recognize that many variations of such embodiments exist. Such variations are intended to be within the scope of the present invention and the appended claims.

What is claimed is:

1. A classified communication method of classifying information in communication, wherein
in a process of allowing sending and receiving sides to confirm correct connection of outward and homeward routes, a secret key is interchanged between the outward and homeward routes in a classified state.

2. A classified communication method of classifying information in communication, wherein
either or both of hardware and software is used to classify destination information needed for data transfer, data type information, a communication state, or a combination of these.

3. A classified communication method of interchanging a secret key in communication, the method comprising the steps of:
sending AA classified from a secret key A by the sender's secret key A;
sending BAA classified by AA received by a receiver's secret key B;
sending BA converted to plaintext by the sender's secret key A; and
obtaining the secret key A converted to plaintext from BA received by the receiver's secret key B.

4. A classified communication method of classifying information in communication, wherein
in a process of allowing sending and receiving sides to confirm correct connection of outward and homeward routes, a secret key is interchanged between the outward and homeward routes in a classified state; and authentication is performed by storing an initially interchanged secret key and a secret key generated by the sending or receiving side itself and additionally using the stored secret keys for the next connection.

5. The classified communication method according to claim 4, the method comprising the steps of:
detecting that a signal error occurs at the receiving side;
discarding error-causing data at the receiving and sending sides or correcting the error-causing data by resending this error-causing data from the sending side; and
thus recovering a state before the sending and receiving sides detect the error.

6. The classified communication method according to claim 4, wherein
a signal is classified between an encoder and a decoder and DC balanced encoding is performed simultaneously.

7. The classified communication method according to claim 4, wherein
authentication is performed to prevent a third party from being disguised as an interested party for communication.

8. A classified communication method of classifying communication, the method comprising the steps of:
sending AA classified from a secret key A by the sender's secret key A;
sending BAA classified by AA received by a receiver's secret key B;
sending BA converted to plaintext by the sender's secret key A; and
obtaining the secret key A converted to plaintext from BA received by the receiver's secret key B to interchange secret keys in classified state;
using hardware or software to classify destination information needed for data delivery, data type information, and presence or absence of communication information;
confirming normal connection of outward and homeward routes at sending and receiving sides;
performing authentication at an initial connection;
encoding a clock and data;
detecting an error occurrence; and
enabling a recovery when an error is detected.

9. A node apparatus for implementing communication classified by a secret key between two nodes, the apparatus comprising:
an encoder to classify information to be sent;
a circuit to generate a factor needed for classification used by the encoder;
a decoder to convert received information to plaintext;
a circuit to generate a factor needed for classification used by the decoder; and
a circuit to simultaneously control confirmation of a normal connection for outward and homeward routes and an interchange of a key.

10. The node apparatus according to claim 9 further comprising:
a buffer to store a key for authentication at both sending and receiving sides.
